(19) United States
(12) Patent Application Publication
(10) Pub. No.: US 2012/0221386 A1
(43) Pub. Date: Aug. 30, 2012

(54) REAL-TIME ONLINE ADVERTISEMENT VERIFICATION SYSTEM AND METHOD

(75) Inventors: Oren Netzer, Wyckoff, NJ (US); Gil Resh, New York, NY (US); Alex Liverant, Givatayim (IL); Gil Wasserman, Rosh Ha'Ayin (IL)

(73) Assignee: DOUBLE VERIFY INC., New York, NY (US)

(21) Appl. No.: 13/508,214

(22) PCT Filed: Nov. 8, 2010
(86) PCT No.: PCT/IL10/00925

§ 371 Date: May 4, 2012

Related U.S. Application Data
(60) Provisional application No. 61/259,256, filed on Nov. 9, 2009.

(51) Int. Cl. G06Q 30/02

(52) U.S. Cl. 705/14.4

(57) ABSTRACT

A real-time system for verifying advertisements against their campaign rules prior to serving them by an ad server that includes: (a) a decision server for deciding whether or not an advertisement intended to be presented to a user matches its campaign rules; (b) a database, which receives a connection from the decision server, the database comprises campaign rules according to publisher's intents; (c) a Web server comprising query SW modules, the server delivers the query SW modules to the user's browser; and (d) a query SW module executed by the user's browser and adapted to extract parameters that are necessary for the decision server; wherein the parameters are delivered to the decision server which analyzes the campaign rules and the parameters provided, and sends its decision to the ad sever which serves or block the advertisement accordingly.

### FIELD OF THE INVENTION

The present invention relates to a system and a method for verifying advertisement delivered over a data network. More particularly, the invention relates to a real-time decision system for verifying advertisement delivered over an Internet-based media, based on Java Script delivery.

### BACKGROUND OF THE INVENTION

When a company buys advertising space or time from a media seller, it includes specific instructions regarding where, when and how this advertising should be delivered. The campaign buying guide lines are compiled after extensive research using various different tools, and from the advertising buyer's perspective, best reflects its advertising goals and represents the optimal use of its advertising budget. The cost of advertising is also directly related to the type and extent of campaign delivery instructions.

The campaign delivery instructions may include the dates and time of the day, in which the advertising should be launched or delivered, the number of times the advertisement should be delivered, the type of audience it should be delivered to, the location of the advertising, the frequency in which it should be delivered, certain sites and URLs to be excluded from the approved sites where the advertisement should be delivered, and other various rules, policies and conventions which the advertising should adhere to.

The order which the advertiser places with the media seller that contains these instructions and that is accepted by the media seller is usually referred to as an “Insertion Order” (IO). An IO usually consists of various placements, where each placement represents a different insertion. The IO represents the written contract between the advertising buyer and the seller pertaining to this advertisement campaign.

The advertising seller delivers the advertisements to its website on the World-Wide-Web or other form of digital media using a computer program usually referred to as an ad server. Every webpage that should display advertising contents is connected to one or more Ad Servers. The ad server selects the appropriate advertisement to be delivered from a large bank of advertisements by matching the most appropriate advertisement, based on the definitions of the IO and placements, with the corresponding user and page.

In many cases an ad server may decide to call a third party to serve an ad (one example is selling inventory to another ad server since the first ad server doesn't have enough advertisements to serve). This may occur recursively and generate a chain of calls from one ad server to another ad server, by redirecting calls from ad server to ad server using the client's browser and generating IFrame tags with calls to those ad servers.

Because of the complexities of the IO, manual processes required to set up campaigns, the short timeframe usually available to set up the campaigns and because of other technological challenges, e.g., third party usage, the actual delivery of the advertisements can frequently differ from the instructions specified in the IO. These inconsistencies cost advertising buyers many millions of dollars of advertising budget wastage. In order to save such a waste, the delivery of advertisements should be monitored and advertisements which do not adhere to the campaign buying guide lines should be blocked in real-time.

A Content Delivery Network or Content Distribution Network (CDN) is a system of computers containing copies of data, placed at various points in a network. so as to maximize bandwidth for access to the data from users throughout the network. By utilizing a CDN, a user can access a copy of the data near by, as opposed to accessing the same central server by all users. Utilizing a CDN avoids the bottleneck otherwise created near the central server. Content types include web objects, downloadable objects (media files, software, and documents), applications, real time media streams, and other components of Internet delivery (DNS, routes, and database queries).

An Inline Frame (IFrame) is a document (e.g., HTML, XML, etc) embedded inside another document (e.g., HTML, XML, etc) on a website. IFrames and nested IFrames elements are often used to deliver advertisements by inserting content from one source, such as an advertisement, into another source, such as a Webpage. Due to the IFrames security definitions, the visibility of the site page parameters (e.g., URL) and data where the advertisement is delivered to is severely limited. The visibility is limited due to security restriction that hides information of the Document object Model (DOM—a programming interface specification for allowing a programmer to create and modify HTML pages and XML documents as full-fledged program objects) outside of the IFrame when the IFrame is in a different domain then its parent or children. The visibility is even more limited when the advertisement is delivered through a chain of ad servers as mentioned hereinabove, creating nested IFrames.

Nested IFrames do not allow campaign buyers to identify the Webpage URL from its conventional and standard data. Therefore, campaign buyers can not check whether their advertisements are targeted to the desired destination and can not block advertisements which are directed to undesired URLs. As a result, campaign buyers sometimes waste their advertisement budget in undesired campaigns. The process of blocking undesired advertisements is even more complicated if the advertisement blocking decision is made in an external service to the ad server. In order to decide accurately which advertisements to block, information (e.g., URL) must be gathered on the page where the advertisement is delivered to. Blocking undesired advertisements should be done on the fly in real-time. To prevent degradation in the advertisement delivery time, the process of advertisement blocking should be done in a short execution time.

One method of extracting URL hidden within an IFrame is disclosed in WO2009/156988. This method offers a specially developed Java Script (JS) code to deliver and execute on the page. The specially developed JS can supply a windows referrer to the IFrame. Thus, the site page parameters visibility is improved and one can decide whether to serve a desired advertisement or not. However, delivering the JS to a Webpage reduces the performance and slows down the advertisement delivery time.

The methods used today have not yet provided satisfactory solutions to the problem of serving an advertisement based on full knowledge and visibility of the page where the advertisement is delivered to. The methods used today perform a decision whether to block or serve the received advertisement in the browser. However, when the advertisement received is blocked the opportunity to display an advertisement on the page is lost and the page is not monetized. Therefore, there is a need for a system that helps an ad server decide which advertisement to serve and allows it to serve appropriate advertisements according to their campaign definitions, based on full knowledge and visibility of the placement of serving (e.g., page URL). Furthermore, there is a need for a method that provides a third party real-time decision system which accomplishes the requirements for accuracy and short advertisement delivery time. It is an object of the present invention to verify that an advertisement served over a data network satisfies its campaign definitions and constraints.

It is another object of the present invention to provide a system for automatically verifying that an advertisement served complies with the advertising Insertion Order as defined by the advertiser.

It is a further object of the present invention to verify that the instructions specified in the Insertion Order matches the advertiser's intent.

Still another object of the present invention is to gain full visibility to the page URL and to shorten the real time advertisement blocking latency to a negligible minimum.

Further purposes and advantages of this invention will appear as the description proceeds.

### SUMMARY OF THE INVENTION

In a first aspect, the invention is directed to a real-time system for verifying advertisements against their campaign rules prior to serving them by an ad server, comprising: (a) a decision server for deciding whether or not an advertisement intended to be presented to a user matches its campaign rules; (b) a database, begin in connection with the decision server, the database comprises campaign rules according to publisher's intents; (c) a Web server comprising query SW modules, the server delivers the query SW modules to the user's browser; and (d) a query SW module executed by the user's browser and adapted to extract parameters that are necessary for the decision server; wherein the parameters are delivered to the decision server which analyzes the campaign rules and the parameters provided, and sends its decision to the ad server which serves or blocks the advertisement accordingly.

In an embodiment of the invention the extracted parameters are taken from the group consisting of: top page accessible URL, window referrer, dates and time of the day in which the advertising should be launched or delivered, the number of times the advertisement should be delivered, the type of audience it should be delivered to, the location of the advertising, the frequency in which it should be delivered, certain sites and URLs to be excluded from the approved sites where the advertisement should be delivered, rules, policies, and conventions which the advertising should adhere to.

In one embodiment, the system further comprises one or more Site Tags which are stored in the Publisher's Webpages, wherein the Site Tags are retrieved and executed by the user's browser and allows the query SW module to extract information on the top page where the advertisement is delivered.

In one embodiment the Site Tag is a code written in a machine language taken from the group consisting of: JS and HTML.

In one embodiment, the system further comprises a secondary code for generating a General User ID for the current advertisement request.

In one embodiment the query SW module is a code written is a machine language taken from the group consisting of JS and HTML.

In a second aspect, the invention is directed to a real-time method of verifying advertisements against their campaign rules prior to serving them by an as server, comprising the steps of: (a) retrieving a Site Tag from a publisher's Webpage; (b) retrieving a query software module from a Web server and executing its code by the user's browser; (c) gathering all the page parameters which are required for the advertisement serving decision; (d) calling a decision server with the collected parameters; (d) retrieving the campaign definitions from a database and comparing with the collected parameters; and (e) deciding whether to serve or block the advertisement base on the comparison.

In one embodiment, the method further comprises generating a General User ID on the user's side, and calling the ad server with the generated General User ID for allowing advertisements serving parallel to decision processing.

In one embodiment, the method further comprising selecting a new advertisement to serve to the Web page instead of the advertisement which verified and blocked for being inappropriate

### BRIEF DESCRIPTION OF THE DRAWINGS

The above and other characteristics and advantages of the invention will be better understood through the following illustrative and non-limitative detailed description of embodiments thereof, with reference to the appended drawings, wherein:

FIG. 1 schematically illustrates an exemplary embodiment of the system according to the present invention; and

FIG. 2 is a sequence diagram of an embodiment of the client-server flow according to the present invention.

### DETAILED DESCRIPTION OF THE INVENTION

In the following description, for the purpose of illustration, numerous specific details are provided. As will be apparent to the skilled person, however, the invention is not limited to such specific details and the skilled person will be able to devise alternative arrangements.

The system proposed by the present invention offers an accurate real-time Advertisement Verification (AV) service which is adapted to verifying advertisements against their campaign rules prior to serving them by an ad server. In one embodiment, the present invention comprises software modules referred hereinafter as Site Tags (STs). Publishers which are interested in the AV service add the ST to their Websites. The ST runs in the background and is adapted to start the process of querying the publisher's site. The query process includes extracting site parameters and information regarding the ‘top page’ where the advertisement is delivered on (such as most top page accessible URL and window referrer), no matter how many IFrames and different domains are in the way between them. This embodiment saves the client the need to employ his own servers, to setup the system, or to activate private applications. The ST is also adapted to communicate with a remote advertising server that delivers the advertisements to the page. The ST sends information to the ad server about the page and about the user accessing this page.

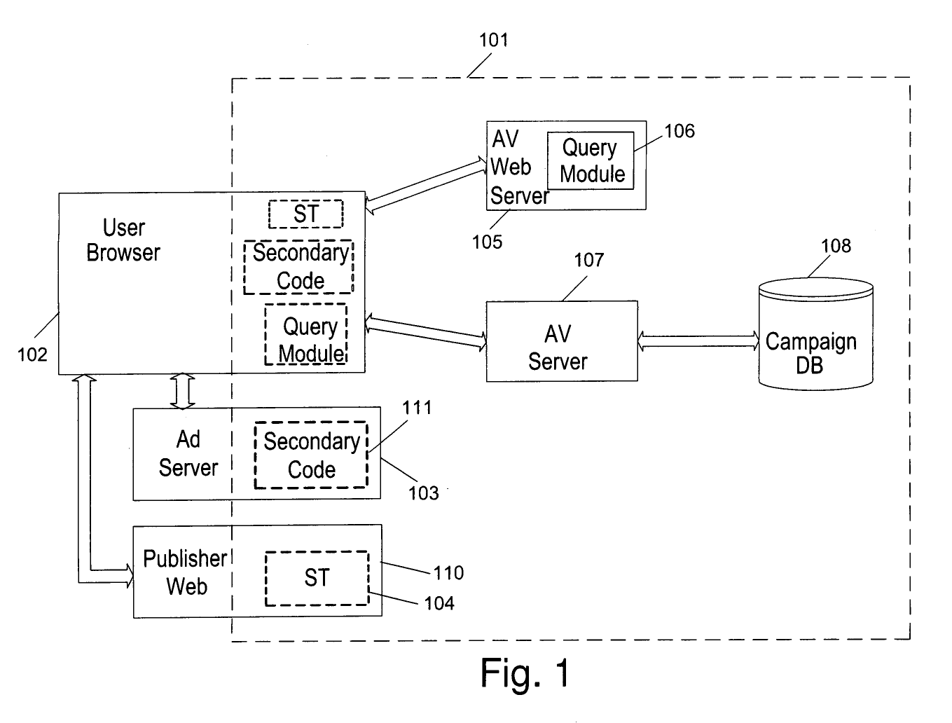

FIG. 1 schematically illustrates an exemplary embodiment of the system according to the present invention. In this embodiment, AV service provider 101 offers advertisement verification services, external to publisher's ad server 103. Each publisher who wishes to be more visible to the real-time AV service uses ST 104. The ST is stored in the publisher's Webpages 110, and executed when the user's browser 102 loads the publisher's Webpages. In one embodiment the ST is a software module which contains JS, HTML or other machine language code. Once the ST is executed it generates a call to ad server 103 and retrieves from it secondary code 11. In one embodiment the secondary code is a JS. When the secondary code is executed by the user's browser a connection is established to AV Web server 105. AV Web server 105 contains query modules 106. In an embodiment of the present invention, Web server 105 is a CDN which contains query module 106 comprises a JS code adapted to extract the parameters that are necessary for deciding whether to serve or not to serve the advertisement (e.g., Web top page URL).

Once the query module is retrieved, the browser executes the JS code in the query module and a process of extracting the URL of the top page (where the advertisement is served) begins. Simultaneously, secondary code 111 also generates a (General User ID) GUID for the current advertisement request. The GUID is a unique identifier which allows asynchronous communication and parallel processing for reducing the advertisements serving time. In one embodiment the GUID allows commencement of advertisements delivery process parallel to decision processing. When the URL is extracted it is sent along with the generated GUID to AV Server 107. Simultaneously, the generated GUID is also sent to ad server 103 which sends the GUID and the campaign ID of the advertisement to AB Server 107. AV Server 107 matches the URL sent from the user's browser and the campaign ID sent from the ad server according to the GUID received from both units, and retrieves the corresponding campaign rules from campaign database (DB) 108.

After analyzing the campaign rules and the URL provided, AV Server 107 decides whether the advertisement should be served or not and sends its decision to ad server 103. According to this decision, ad server 103 serves or blocks the advertisement. When the advertisement does not satisfy its campaign definitions and constraints it is blocked, namely, the ad server does not serve the current advertisement. However, the opportunity to serve an advertisement to the page is not lost, the real time occurrence allows the ad server to select a new advertisement to serve instead of the advertisement which verified and blocked for being inappropriate to the current placement. Thus, the present invention automatically verifies that an advertisement served complies with the advertising insertion Order as defined by the advertiser.

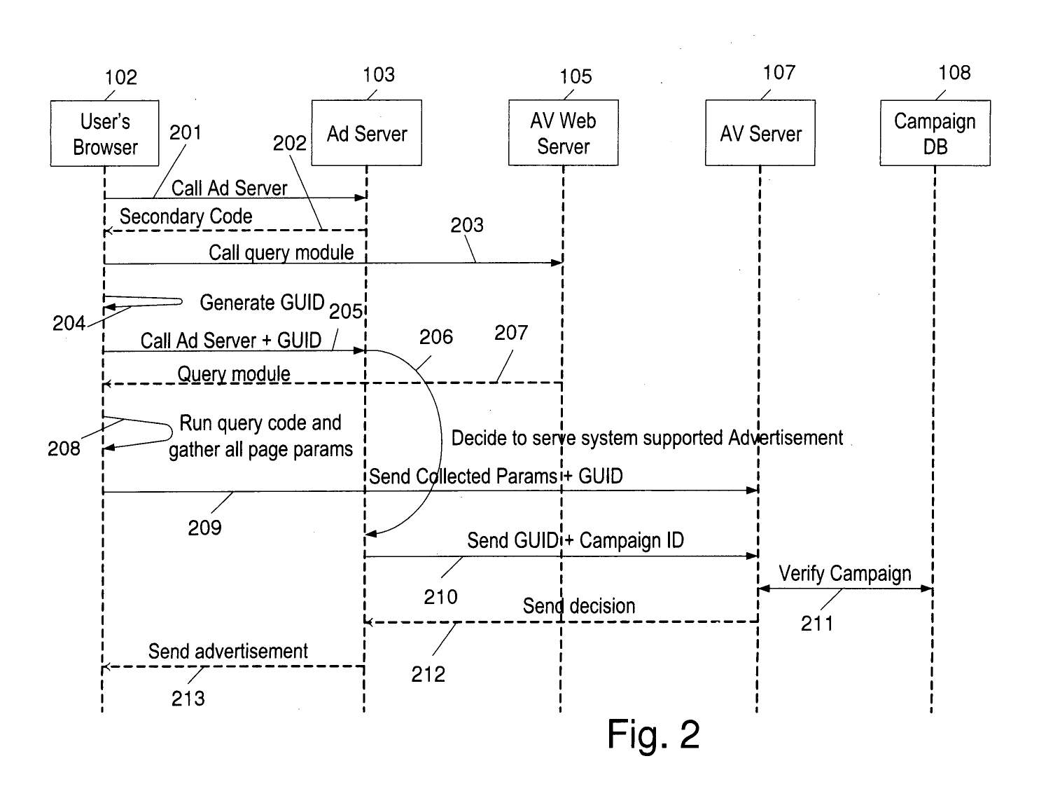

FIG. 2 is a sequence diagram of an embodiment of the client-server flow according to the present invention. As mentioned hereinabove, each publisher who wishes to be more transparent to the blocking service adds Site Tags (STs) to its Website. When a user visits the publisher Website, its browser loads the code in the ST along with the Webpages. The ST execution in the browser starts the entire process. In step 201 a call is made from the user's browser 102 to ad server 103 to retrieve the secondary code. In return, the secondary code is delivered back to the browser in step 202. In step 203 a call is made to AV Web server 105 to retrieve the query SW module.

In one embodiment, the query SW module is a JS code. The query SW module is adapted to generate the parameters required by the AV server 107 to make a decision whether or not to serve an advertisement. This call is made simultaneously with the next steps. In step 204, user's browser 102 generates a GUID on the user's side, and a call is made in step 205 from the browser to the ad server with the generated GUID. In one embodiment of the present invention the GUID generation, query SW module retrieval, and ad server calling are all initiated by the secondary code. In step 206, the ad server chooses an advertisement to serve. In step 207 the query SW module returns from the AV CDN and is executed by the browser in step 208. Running the code allows the browser to gather all the page parameters which are required for the advertisement serving decision. In step 209 a call is made to AV server with the collected parameters and the GUID.

In step 210 the GUID received in step 205, and the campaign parameters are sent to the AV server 107 for deciding whether or not to served the advertisement on this page. In step 211 the AV server retrieves the campaign definitions from the campaign DB 108, and checks whether the advertisement parameters and top page URL match the campaign requirements. In step 212 a decision is sent back to the ad server whether to serve or to block the advertisement. The selected advertisement is then sent back to the user in step 213.

There are several ways of implementation which can be used for data transfer and sharing between a Website and its IFrames. For example, a client storage (where data is stored within the browser), a cross domain integration (which is an interface in HTML 5 standard), a cookie which can transfer within the same domain. Cookies are a preferred solution when considering cross browser support (work with different versions of browsers), and stability of solution. Moreover, it allows the simplest implementation and best performance with real time blocking. Nevertheless, any available way to communicate Website data into the IFrame can be utilized by the system of the present invention, in order to achieve visibility from the IFrame to the Website data.

In one embodiment the tag is implemented on the publisher's pages. The tag contains Java Script (JS) code that generates an IFrame with a call to a static html file in the service provider's domain, for example (http://cdn.avserver.com/sitetag.htm). This file contains JS code that adds a short lived user side session cookie (which runs on the user side).

The Site Tag is used to provide site information to tags that are served within the IFrame. For example, in cases where a normal tag is served with all advertisements that are tracked by the system according to the present invention, a tag is used that generates 0×0 image (tracking pixel) that calls AV Server (http://log1.avserver.com/visitor.aspx). In this call's header, the cookie that has been saved before (in the client side) is sent. This allows the server to know the exact Webpage URL.

In another embodiment, the tag contains Java Script (JS) code that uses the HTML5 postMessage API which allows sending messages between windows in a browser. The JS code running on the publisher side registers to listening to a message event. Once this event occurs it returns the URL of the page to the sender of the message. In order for another JS running in a nested IFrame to get the top most URL it needs to use postMessage API to send a message to the top most page and then the ST listener returns the URL.

The above examples and description have of course been provided only for the purpose of illustration, and are not intended to limit the invention in any way. As will be appreciated by the skilled person, the invention can be carried out in a great variety of ways, employing more than one technique from those described above, all without exceeding the scope of the invention.

1. A real-time system for verifying advertisements against their campaign rules prior to serving them by an ad server, comprising:
(a) a decision server for deciding whether or not an advertisement intended to be presented to a user, matches its campaign rules;
(b) a database, which receives a connection from said decision server, said database comprises campaign rules according to publisher's intents;
(c) a Web server comprising query SW modules, said server delivers said query SW modules to said user's browser; and
(d) a query SW module executed by said user's browser and adapted to extract parameters that are necessary for said decision server,
wherein said parameters are delivered to said decision server, which analyzes the campaign rules and the parameters provided, and sends its decision to said ad server, which serves or blocks said advertisement accordingly.

2. The system according to claim 1, wherein the extracted parameters are taken from the group consisting of: top page accessible URL, window referrer, dates and time of the day in which the advertising should be launched or delivered, the number of times the advertisement should be delivered, the type of audience it should be delivered to, the location of the advertising, the frequency in which it should be delivered, certain sites and URLs to be excluded from the approved sites where the advertisement should be delivered, rules, policies, and conventions which the advertising should adhere to

3. The system according to claim 1, further comprising one or more Site Tags which are stored in the Publisher's Webpages, wherein said Site Tags are retrieved and executed by the user's browser and allows the query SW module to extract information on the top page where the advertisement is delivered.

4. The system according to claim 3, wherein the Site Tag is a code written in a machine language taken from the group consisting of: JS and HTML.

5. The system according to claim 3, further comprising a secondary code for generating a General User ID for the current advertisement request.

6. The system according to claim 1, wherein the query SW module is a code written is a machine language taken from the group consisting of: JS and HTML.

7. A real-time method of verifying advertisements against their campaign rules prior to serving them by an ad server, comprising the steps of:
(a) retrieving a Site Tag from a publisher's Webpage;
(b) retrieving a query software module from a Web server and executing its code by the user's browser;
(c) gathering all the page parameters which are required for the advertisement serving decision;
(d) calling a decision server with the collected parameters;
(e) retrieving the campaign definitions from a database and comparing with the collected parameters; and
(f) deciding whether to serve or block the advertisement based on said comparison.

8. The method of claim 7, further comprising generating a General User ID on the user's side, and calling the ad server with the generated General User ID for allowing commencement of advertisements delivery process parallel to decision processing.

9. The method of claim 7, further comprising selecting a new advertisement to serve to the Web page instead of the advertisement which verified and blocked for being inappropriate.
